(19) United States
(12) Patent Application Publication
(10) Pub. No.: US 2024/0373293 A1
(43) Pub. Date: Nov. 7, 2024

(54) QUALITY OF SERVICE (QoS) TRANSLATION

(71) Applicant: Cisco Technology, Inc., San Jose, CA (US)

(72) Inventors: Vinay SAINI, Bommanahalli (IN); Jerome HENRY, Pittsboro, NC (US); Robert E. BARTON, Richmond (CA)

(73) Assignee: Cisco Technology, Inc., San Jose, CA (US)

(21) Appl. No.: 18/310,633

(22) Filed: May 2, 2023

(51) Int. Cl. H04W 28/24

(52) U.S. Cl. CPC H04W 28/24

(57) ABSTRACT

Quality of Service (QOS) translation may be provided. An identifier of a client device and an indication that the client device supports translation between a Quality of Service (QOS) treatment in a first wireless protocol and a QoS treatment in a second wireless protocol may be received from the first client device. Then a QoS level associated with the client device in the first wireless protocol may be determined. Next, the QoS level associated with the client device in the first wireless protocol may be mapped to a QoS level associated with the client device in the second wireless protocol. The QoS level associated with the client device in the second wireless protocol may then be applied to wireless traffic between the computing device and the client device.

### TECHNICAL FIELD

The present disclosure relates generally to providing Quality of Service (QOS) translation.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Quality of Service (QOS) translation;

FIG. 2 is a flow chart of a method for providing QoS translation; and

FIG. 3 is a block diagram of a computing device.

### DETAILED DESCRIPTION

### Overview

Quality of Service (QOS) translation may be provided. An identifier of a client device and an indication that the client device supports translation between a Quality of Service (QOS) treatment in a first wireless protocol and a QoS treatment in a second wireless protocol may be received from the first client device. Then a QoS level associated with the client device in the first wireless protocol may be determined. Next, the QoS level associated with the client device in the first wireless protocol may be mapped to a QoS level associated with the client device in the second wireless protocol. The QoS level associated with the client device in the second wireless protocol may then be applied to wireless traffic between the computing device and the client device.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Mobility between Wi-Fi and Fifth Generation (5G)-based systems may be a common scenario for both private and public access scenarios. However, in terms of Quality of Service (QOS), both systems may process frames in their own way and there may be no mechanism for them to share QoS markings and use them natively with technology. Embodiments of the disclosure may fill this gap and may provide processes for 5G QoS Identifier (5QI) (or QoS Class Identifier (QCI)) to Wi-Fi Multimedia (WMM) mapping.

Wi-Fi-6 may be a trusted access companion for any kind of heterogeneous wireless access services including private 5G. Traffic from the private 5G or public 5G may be offloaded to a Wi-Fi Access Point (AP) and may be tunneled to the 5G packet core system using different processes. However, this may present a challenge from the QoS and traffic routing perspective because 5G may use a different treatment (i.e., 5QI) for the QoS management on its network while Wi-Fi may use WMM-based QoS treatments. Embodiments of the disclosure may translate, for example, between the 5QI treatment and WMM treatment. This may occur, for example, in two cases. First, when a client device navigates between outdoor and indoor, passing from the 5G domain to the Wi-Fi domain at regular intervals (and vice versa). Secondly, when the client device uses both the 5G link and the Wi-Fi link at the same time, where there may be a requirement that the Uplink (UL) traffic would reach the upstream server at approximatively the same time (thus with the same QoS treatment along the way) regardless of the path taken.

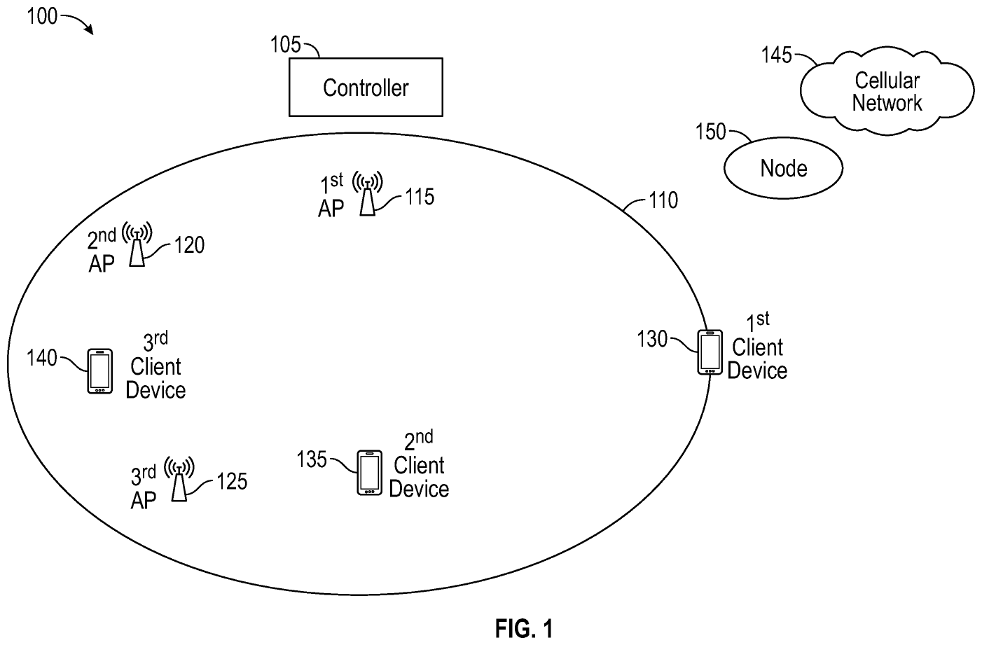

FIG. 1 shows an operating environment 100 providing QoS translation. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. The plurality of APs may provide wireless network access to a plurality of client devices as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi-Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide QoS translation.

Operating environment 100 may further comprise a cellular network 145. Cellular network 145 may comprise, but is not limited to, a Long-Term Evolution (LTE) broadband cellular network, a Fourth Generation (4G) broadband cellular network, or a Fifth Generation (5G) broadband cellular network, operated by a service provider as public or a private network. Cellular network 145 may further include node 150. Node 150 may comprise a device that may be connected to cellular network 145 that may communicate directly and wirelessly with the plurality of client devices (e.g., first client device 130, second client device 135, and third client device 140). Node 150 may comprise, but is not limited to, an evolved NodeB (i.e., eNodeB or eNB) or a Next Generation NodeB (i.e., gNodeB or gNB). Any of the plurality of client devices may receive wireless service from coverage environment 110 and/or from cellular network 145.

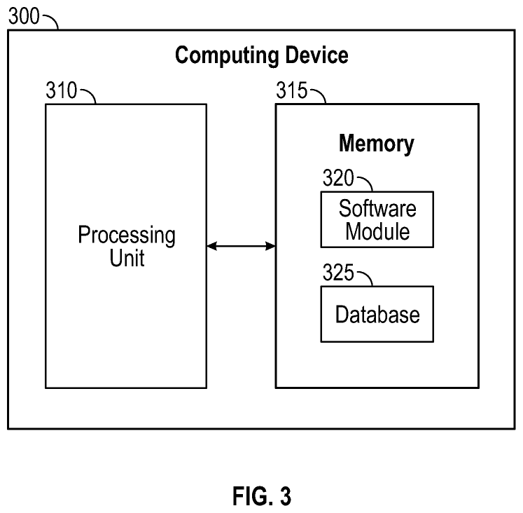

The elements described above of operating environment 100 (e.g., controller 105, first AP 115, second AP 120, third AP 125, first client device 130, second client device 135, third client device 140, or node 150) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

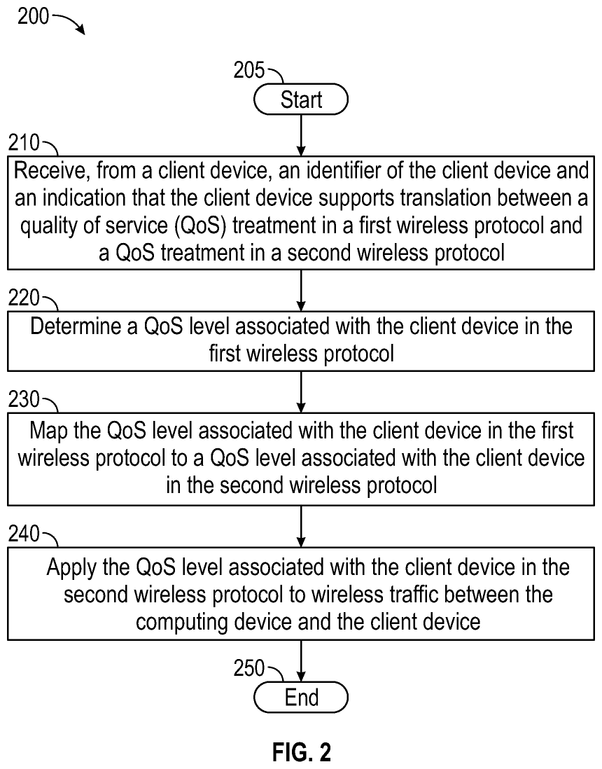

FIG. 2 is a flow chart setting forth the general stages involved in a method 200 consistent with embodiments of the disclosure for providing QoS translation. Method 200 may be implemented using first AP 115 as described in more detail above with respect to FIG. 1. Ways to implement the stages of method 200 will be described in greater detail below.

Quality of service (QOS) is the description or measurement of the overall performance of a service, such as a telephony or computer network, or a cloud computing service, particularly the performance seen by the users of the network. To quantitatively measure quality of service, several related aspects of the network service are often considered, such as packet loss, bit rate, throughput, transmission delay, availability, and jitter for example.

WMM is a Wi-Fi Alliance interoperability certification, based on the IEEE 802.11e standard. It may provide basic QoS features to Institute of Electrical and Electronics Engineers (IEEE) 802.11 networks. WMM may prioritizes traffic according to four Access Categories (AC): i) voice (AC_VO); ii) video (AC_VI); iii) best effort (AC_BE); and iv) background (AC_BK). It may be suitable for well-defined applications that may require QoS, such as Voice over IP (VOIP) on Wi-Fi phones (VoWLAN).

5QI may comprise a pointer to a set of QoS characteristics such as priority level, packet delay or packet error rate, etc. These QoS characteristics may either be standardized or non-standardized. 5QI may be used in 5G networks. QCI may be similar and may be used in LTE networks.

Method 200 may begin at starting block 205 and proceed to stage 210 where first AP 115 may receive, from first client device 130, an identifier of first client device 130 and an indication that first client device 130 supports translation between a Quality of Service (QOS) treatment in a first wireless protocol and a QoS treatment in a second wireless protocol. For example, the first wireless protocol may comprise 5G and the QoS treatment in the first wireless protocol may comprise 5QI. The second wireless protocol may comprise Wi-Fi and the QoS treatment in the second wireless protocol may comprise WMM.

Consistent with embodiments of the disclosure, first AP 115 may send a special Information Unit (IE) in beacons or probe responses showing that it may support private 5G access. In addition, first AP 115 may also send its associated parameters (e.g., Access Point Name (APN)/Data Network Name (DNN). If first client device 130 sees the configuration for the matching DNN/APN, it may share the details about the support for the private 5G at the time of association via special IE. In another embodiment, the information may shared after association in a Protected Management Frame (PMF) action frame. Information included may comprise the DNN/APN and client device identity details such as Subscription Permanent Identity (SUPI), International Mobile Subscriber Identity (IMSI), and/or Network Access Identifier (NAI).

First client device 130 may be onboarded in many different ways. For example, onboarding processes may comprise Extensible Authentication Protocol (EAP)-Authentication and Key Agreement (AKA)/Extensible Authentication Protocol (EAP)-Subscriber Identity Module (SIM) providing details about the identity of first client device 130 to first AP 115.

From stage 210, where first AP 115 receives, from first client device 130, the identifier of first client device 130 and the indication that first client device 130 supports translation between the QoS treatment in the first wireless protocol and the QoS treatment in the second wireless protocol, method 200 may advance to stage 220 where first AP 115 may determine a QoS level associated with first client device 130 in the first wireless protocol. For example, first client device 130 may need to send some traffic over the Wi-Fi link and may expect the QoS treatment to be the same as on the 5G link. Although the standard may allow the gNB (e.g., node 150) to share the 5QI value (i.e., the QoS level associated with first client device 130) with first client device 130, the gNB may not forward the 5QI value to first client device 130. This is because first client device 130 may not use the 5QI value for its transmission on the 5G link, but applies the 5QI to the traffic of first client device 130. In one embodiment, first client device 130 may have the 5QI value from the 5G packet core because the gNB may have sent the 5QI value to first client device 130. First client device 130 may provide its assigned 5QI value (i.e., the QoS level associated with first client device 130) to first AP 115 via a 5QI update IE.

In another embodiment, first client device 130 may not have received the 5QI value from the 5G side (e.g., node 150). Instead, first client device 130 may send to first AP 115 a modified Stream Classification Service (SCS) request that also requests 5G 5QI treatment (e.g., adding an IE-5QI request IE). First AP 115 may fetch the 5QI value from the packet core (e.g., in cellular network 145) for first client device 130 by submitting unique identifiers, for example, first client device 130's 5G SUPI that may include the IMSI and NAI of first client device 130 along with a flow identifier.

Once first AP 115 determines the QoS level associated with first client device 130 in the first wireless protocol in stage 220, method 200 may continue to stage 230 where first AP 115 may map the QoS level associated with first client device 130 in the first wireless protocol to a QoS level associated with first client device 130 in the second wireless protocol. For example, first AP 115 may create a mapping for client traffic QoS queue in its local data base. In other words, first AP 115 may determine a quality level in WMM that is congruent to that of the fetched 5QI value. In the augmented SCS response, first AP 115 may inform first client device 130 about the WMM UL values expected for the flow, but also optionally about the 5QI value.

After first AP 115 maps the QoS level associated with first client device 130 in the first wireless protocol to a QoS level associated with first client device 130 in the second wireless protocol in stage 230, method 200 may proceed to stage 240 where first AP 115 may apply the QoS level associated with first client device 130 in the second wireless protocol to wireless traffic between first AP 115 and first client device 130. For example, first client device 130 may apply a policy on its uplink traffic corresponding to the quality level in WMM that is congruent to that of the fetched 5QI value. When the return traffic reaches first AP 115, it may use the 5QI to WMM mapping processes for traffic priorities on the Downlink (DL) Wi-Fi side and appropriate mapping on the UL ethernet side.

In one embodiment, first AP 115 may differentiate the traffic that would have been sent through the 5G link (if it were to be available), or that may need the same treatment on the 5G link as on the Wi-Fi link (i.e., traffic type 1), from the traffic that may not need specific 5G treatment (i.e., traffic type 2). In one embodiment, the augmented SCS request case may only apply to traffic type 1. In another embodiment, the 5QI update IE may be used to distinguish traffic type 1 from traffic type 2. For traffic type 1, first AP 115 may be aware of specific anchor points for that specific APN/DNN and it may create a direct tunnel to that Multi-Access Edge Computing (MEC)/Point of Presence (POP) with QoS marking derived from the 5QI to WMM mapping. Once first AP 115 applies the QoS level associated with first client device 130 in the second wireless protocol to wireless traffic between first AP 115 and first client device 130 in stage 240, method 200 may then end at stage 250.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing QoS translation as described above with respect to FIG. 2. Computing device 300, for example, may provide an operating environment for controller 105, first AP 115, second AP 120, third AP 125, first client device 130, second client device 135, third client device 140, or node 150. Controller 105, first AP 115, second AP 120, third AP 125, first client device 130, second client device 135, third client device 140, or node 150 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving, by a computing device from a client device, an identifier of the client device and an indication that the client device supports translation between a Quality of Service (QOS) treatment in a first wireless protocol and a QoS treatment in a second wireless protocol;
determining a QoS level associated with the client device in the first wireless protocol;
mapping the QoS level associated with the client device in the first wireless protocol to a QoS level associated with the client device in the second wireless protocol; and
applying the QoS level associated with the client device in the second wireless protocol to wireless traffic between the computing device and the client device.

2. The method of claim 1, further comprising sending, by the computing device to the client device, an indication that the computing device supports the first wireless protocol.

3. The method of claim 1, wherein the first wireless protocol comprises a protocol associated with a cellular network.

4. The method of claim 1, wherein the first wireless protocol comprises one of 4G and 5G.

5. The method of claim 1, wherein the second protocol comprises Wi-Fi.

6. The method of claim 1, wherein the computing device comprises an Access Point (AP).

7. The method of claim 1, wherein determining the QoS level associated with the client device in the first wireless protocol comprises receiving the QoS level associated with the client device in the first wireless protocol from the client device.

8. The method of claim 1, wherein determining the QoS level associated with the client device in the first wireless protocol comprises receiving the QoS level associated with the client device in the first wireless protocol from a first wireless network.

9. A system comprising:
a memory storage; and
a processing unit disposed in a first computing device and coupled to the memory storage, wherein the processing unit is operative to:
receive, from a client device, an identifier of the client device and an indication that the client device supports translation between a Quality of Service (QOS) treatment in a first wireless protocol and a QoS treatment in a second wireless protocol;
determine a QoS level associated with the client device in the first wireless protocol;
map the QoS level associated with the client device in the first wireless protocol to a QoS level associated with the client device in the second wireless protocol; and
apply the QoS level associated with the client device in the second wireless protocol to wireless traffic between the computing device and the client device.

10. The system of claim 9, wherein the first wireless protocol comprises a protocol associated with a cellular network.

11. The system of claim 9, wherein the first wireless protocol comprises one of 4G and 5G.

12. The system of claim 9, wherein the second protocol comprises Wi-Fi.

13. The system of claim 9, wherein the processing unit being operative to determine the QoS level associated with the client device in the first wireless protocol comprises the processing unit being operative to receive the QoS level associated with the client device in the first wireless protocol from the client device.

14. The system of claim 9, wherein the processing unit being operative to determine the QoS level associated with the client device in the first wireless protocol comprises the processing unit being operative to receive the QoS level associated with the client device in the first wireless protocol from a first wireless network.

15. A non-transitory computer-readable medium that stores a set of instructions which when executed perform a method executed by the set of instructions comprising:
receiving, by a computing device from a client device, an identifier of the client device and an indication that the client device supports translation between a Quality of Service (QOS) treatment in a first wireless protocol and a QoS treatment in a second wireless protocol;
determining a QoS level associated with the client device in the first wireless protocol;
mapping the QoS level associated with the client device in the first wireless protocol to a QoS level associated with the client device in the second wireless protocol; and
applying the QoS level associated with the client device in the second wireless protocol to wireless traffic between the computing device and the client device.

16. The non-transitory computer-readable medium of claim 15, wherein the first wireless protocol comprises a protocol associated with a cellular network.

17. The non-transitory computer-readable medium of claim 15, wherein the first wireless protocol comprises one of 4G and 5G.

18. The non-transitory computer-readable medium of claim 15, wherein the second protocol comprises Wi-Fi.

19. The non-transitory computer-readable medium of claim 15, wherein determining the QoS level associated with the client device in the first wireless protocol comprises receiving the QoS level associated with the client device in the first wireless protocol from the client device.

20. The non-transitory computer-readable medium of claim 15, wherein determining the QoS level associated with the client device in the first wireless protocol comprises receiving the QoS level associated with the client device in the first wireless protocol from a first wireless network.
